(19) United States
(12) Patent Application Publication
(10) Pub. No.: US 2006/0021758 A1
(43) Pub. Date: Feb. 2, 2006

(54) Equine hoof pad for break over modification

(76) Inventors: Eugene D. Ovnicek, Penrose, CO (US); Micheal L. Steward, McLoud, OK (US)

Correspondence Address: HANES & SCHUTZ, LLC, 102 SOUTH TEJON ST., SUITE 800, COLORADO SPRINGS, CO, 80903, US

(21) Appl. No.: 10/909,209

(22) Filed: Jul. 30, 2004

(51) Int. Cl. A01L 3/00

(52) U.S. Cl. 168/4

(57) ABSTRACT

A hoof pad for treatment of equine lower limb pathology comprising, a pad formed of rigid material having an upper hoof contacting surface spaced apart from a lower flat surface that is adapted for ground contact or for mounting of a supplemental pad, the anterior, posterior, medial and lateral side surfaces being sloped and curvilinearly interconnected and where the anterior and posterior side surfaces have a lesser slope than the medial and lateral side surfaces, said pad having a plan view shape substantially similar to that of the ground contacting surface of a horse's hoof, but laterally wider.

### FIELD OF THE INVENTION

The present invention relates to equine hoof appliances primarily intended for animals afflicted with lameness but which can be useful for sound horses in some disciplines.

### BACKGROUND OF THE INVENTION

Equine lameness can be caused by a large variety of lower limb pathologies. Laminitis, ringbone and navicular inflammation are among the most common, all of which will favorably respond to a restriction of movement of the distal phalanges joints, as is achieved by the apparatus and method of the present invention. The present invention will be best explained by reference to its use in the exemplar treatment of one particular pathology, laminitis.

Basically, laminitis is an inflammation of the laminae in a horse's hoof caused by a number of different factors, including grain overload, steroid therapy, retained placenta, colic, toxins, generalized disease and others. More specifically, laminitis is a common, painful, and potentially disastrous condition of the horse foot where there is a partial or total failure of the attachment tissue between the coffin bone (distal or third bone of the distal phalanges) and the inner aspect of the hoof wall. The coffin bone is suspended in the hoof, attached by an arrangement of structures called laminae to the inside surface of the hoof wall. Finger-like dermal (sensitive) laminae grow outwardly from the laminar dermis attached to the coffin bone and interdigitate with corresponding epidermal (insensitive) laminae that project inwardly from the inner surface of the hoof. The interconnection of the dermal and epidermal laminae anchors the coffin bone to the hoof wall.

Acute laminitis, or founder, occurs when the dermal laminae no longer fully retain the epidermal laminae, resulting in lameness. As inflammation from this acute condition increases, edema may occur, causing ischemia and the resulting death of the laminae. As the condition continues and worsens, the laminae in the front of the hoof that carry most of the weight of the horse will stretch and tear, allowing the coffin bone to entirely pull away from the hoof wall. This allows the distal border of the coffin bone (the crescent shaped part of the coffin bone that is the bottom front of the bone) to drop, or rotate, to varying degrees. In severe cases all of the laminae die and the coffin bone sinks and may drop through the bottom of the hoof, resulting in a condition of chronic laminitis.

Proper treatment of laminitis includes many different therapies because the cause is usually systemic, however in addition to dietary restrictions and drugs, non-surgical regimes may be applied to the hoof to relieve pain and stabilize the coffin bone to promote the healing process. In the past these non-surgical treatments have included corrective trimming of the hoof, application of frog supports and the use of therapeutic shoes or pads, such as the heart bar shoe and the devices disclosed in U.S. Patents to Ovnicek, Nos. 5,253,715, 5,439,062 and 5,727,633. These methods and devices have, for the most part, achieved only limited success.

Because these prior art treatment regimens have shortcomings, it is the primary object of the present invention to avoid therapeutic horse shoes and instead provide a system of novel hoof pads and a method for their application that will significantly reduce the pain of laminitis and will accelerate healing.

A correlative object of the invention is to provide a hoof pad that will serve to move the break over in a horse's hoof posteriorly of its normal position.

A further object of the invention is to provide apparatus that will permit a wide range of break over adjustments, whether they are anteriorly, posteriorly, medially or laterally of the normal position.

A still further object of the invention is to provide apparatus and a method that will implement a wide range of adjustments that can be made easily and the results of which can be seen immediately.

Other objects, features and advantages of the present invention will be apparent on a reading of the following description of a preferred form of the invention, taken in conjunction with the accompanying drawings.

### SUMMARY AND THEORY OF THE INVENTION

The present invention is based on the discovery that laminitis and other lower limb pathologies may be greatly benefited if the break over point of the affected hoof is moved posteriorly from its normal position at or below the toe of the hoof, to a position closer to or caudel to the dorsal distal border of the coffin bone. This relocation of the break over results in both immediate pain relief and the acceleration of healing by relieving stress on the laminae, in laminitis cases, and reducing irritation to the distal phalanx (P3) joint when ring bone or navicular problems are the concern.

Break over, as referred to in this specification, is that point in the movement of a horse's limb when the carrying function of the forelimb ends and the horse's knee bends, lifting the heel of the hoof off of the ground and beginning the rotation of the hoof about its toe.

While the normal load carrying function of the limb is reduced during break over, significant forces are still applied against various portions of the hoof until it is completely released from the ground. Because the most significant break over forces are brought to bear against the toe of the hoof, break over forces exacerbate the pain related to the pathology and tend to promote its continued development. Prior to break over, the force produced against the bottom of an unshod or normally shod hoof is distributed over the entire area of the hoof. However, at break over the upward force is concentrated on the hoof wall. The upward resultant force produced by the ground contact, together with the downward force generated by the horse's weight develops a force couple that tends to bend the wall of the hoof into slight concavity, pulling it away from the coffin bone. If the laminae are inflamed or already stretched or torn, the force produced on the toe of the hoof at break over increases the strain on the laminae, the attaching ligaments, tendons and joints of the phalanges bones, thus exacerbating an already injurious condition that intensifies the horse's pain and obstructs the healing process.

On the other hand, if the break over is reset to a position below the dorsal distal border of the coffin bone, the resultant upward force tends to restrain the coffin bone from further rotation and promotes the healing process by urging the coffin bone into its proper position with respect to the wall of the hoof.

Repositioning of the break over is accomplished in the present invention by securing a novel pad to the underside of the affected hoof. In its plan view, the pad is shaped similar to the ground-contacting surface of the horse's hoof. The depth or thickness of the pad will vary with the size of the foot the device is being applied to and is also a function of the distance that the break over is to be moved axially to the periphery of the hoof wall. The anterior or front surface of the pad is tapered or sloped rearwardly from the pad's hoof-contacting upper surface toward its ground-contacting surface. The line of intersection between the planar ground-contacting surface of the pad and the sloped anterior surface of the pad constitutes the modified break over line.

While the sloping front surface of the pad of the present invention is significant in accomplishing the objectives of the invention, a sloping forward edge of a hoof appliance is not new, in and of itself. See, for example, the horseshoes disclosed in U.S. Pat. Nos. 5,566,765 and 4,253,526 and the U.S. patents referred to earlier in this specification that all have rearwardly sloping front edge surfaces. While these sloping front surfaces are disclosed in prior patents, none of the devices incorporating the tapered front portions can function to perform the same therapeutic function as specifically intended for the pad of the present invention, as will subsequently become apparent as the description proceeds.

In addition to the sloping anterior surface of the pad, its posterior, medial and lateral edge surfaces are also tapered inwardly toward the center of the pad. This novel aspect of the invention deals with the heretofore-overlooked issue of lateral movement and strain on ligaments, tendons and the digital phalanges' joints that aggravates and intensifies lower limb pathology. Because each case of laminitis or joint arthritis has special requirements for the relief of medial or lateral strain, it may be necessary to offer more break over relief to one side of the limb than to the other. Moreover, each limb may have separate requirements for optimal relief.

When specialized adjustments of the break over are necessary, it may not be sufficient to confine the adjustment mechanism to the primary pad, already described. Accordingly, the present invention includes the provision for attaching a supplemental pad to the flat bottom surface of the primary pad. The preferred supplemental pads significantly reduce the size of the ground-contacting footprint of the primary hoof pad and are shaped to perform a specific adjustment that may be required; including tapered anterior, posterior, medial and lateral surfaces. Similarly purposed supplemental pads can also be shaped as wedges that can raise or lower either of the respective sides of the hoof or its front or back portion, depending on the adjustment needed. Additional shapes may be used, including flat, square, round or crowned and are adapted to be attached to the primary pad in any configuration to obtain equilibrium for the distal phalanges. Unlike horseshoes that have sloping front edges, the pad of the present invention is unique in its ability to mount supplemental pads for more specific treatment.

To avoid further trauma to the patient, the primary or first pad is preferably attached to the hoof by screws and/or by gluing. Special screws are pre-set in the hoof wall from the top or proximal side and screwed downwardly into the upper hoof-contacting surface of the primary pad. Glue may complement the screws to further insure the attachment of the primary pad to the sole of the hoof.

### DESCRIPTION OF THE DRAWINGS

FIGS. 1a-1c are demonstrative lateral cross sectional fragmentary views of the lower limb and hoof of a horse showing, in FIG. 1a, a mild case of laminitis and in FIGS. 1b and 1c, moderate and severe cases respectively.

FIG. 2 is a perspective view of the primary hoof pad of the present invention.

FIG. 3 is a cross sectional view of a typical horse's hoof and phalanges with the primary hoof pad of the present invention, also shown in cross section, attached to the ground contacting surface of the hoof.

FIG. 4 is a front view of the hoof pad of the present invention.

FIG. 5a-5c illustrate exemplary supplemental pads that can be attached to the bottom or ground contacting side of the primary pad.

FIG. 6 is a quartering front view of a horse's hoof to which both a primary pad and a supplemental pad are attached.

FIG. 7 is a front view of a horse's hoof showing the primary pad in place beneath the ground contacting surface of the hoof and illustrating the placement of the fastening screws and additional adhesive that secure the pad to the hoof.

FIG. 8 is lateral cross sectional view of a horse's hoof having a primary pad in place beneath the ground-contacting surface of the hoof and showing intermediate supports for extraordinary spacing of the pad away from the sole of the hoof in severe cases of laminitis.

FIG. 9 is a fragmentary cross section taken along lines 9-9 of FIG. 8.

FIG. 10 is similar to FIG. 7, a front view of a horse's hoof showing the primary pad in place beneath the ground contacting surface of the hoof and illustrating an alternative placement of the fastening screws that do not penetrate the hoof wall and additional adhesive that secure the pad to the hoof.

### DETAILED DESCRIPTION OF THE INVENTION

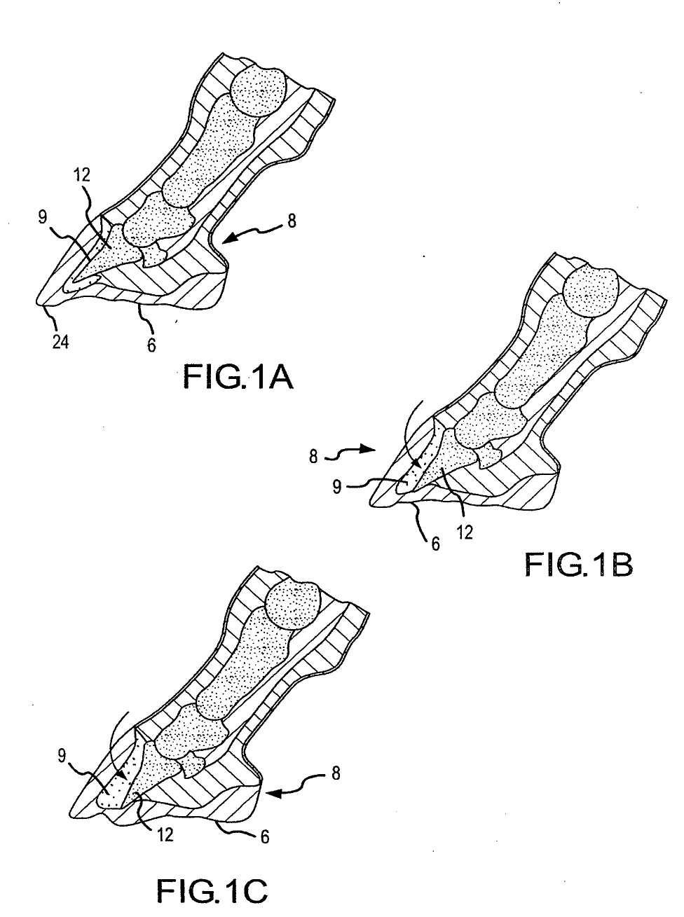

FIGS. 1a-1c respectively illustrate in diagrammatic form three typical states or phases of equine laminitis, mild, moderate and severe. In each case the coffin bone 12 of the horse's hoof 8 has prolapsed out of its normal position as a result of the partial or complete failure of the interdigitated laminae 9. As earlier stated, laminitis is it not the only pathology treatable with the apparatus and method of the present invention, however the accompanying drawings and this description will focus on laminitis to best explain the present invention.

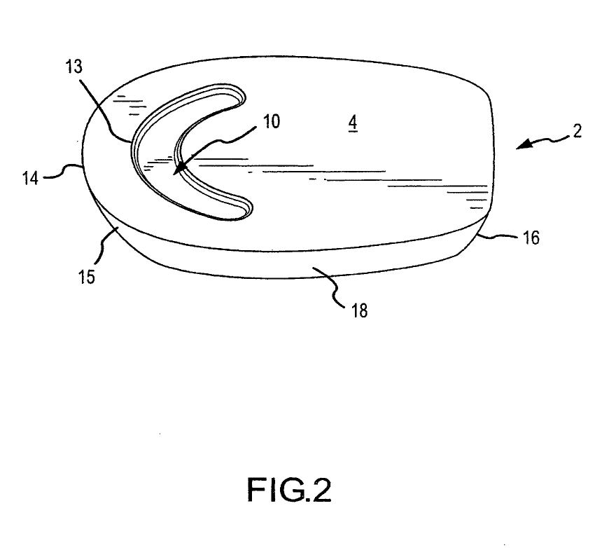

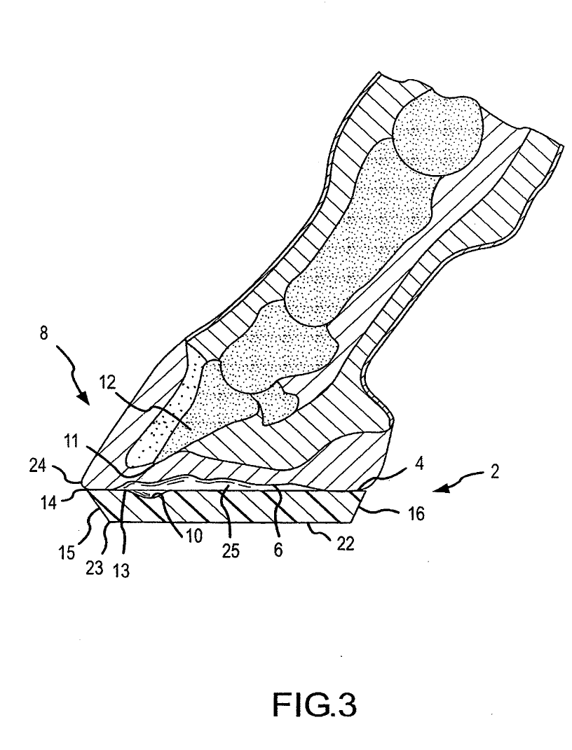

The primary pad 2 of the present invention is shown in FIG. 2. The pad comprises a block of rigid material having a flat upper surface 4 intended for mounting against the bottom ground-contacting surface 6 of the horse's hoof 8, as seen in FIG. 3. The forward portion of the flat upper surface 4 is relieved to form a trough 10 that is crescent shaped, similar to the peripheral distal border 11 of the coffin bone 12, and having a convex anterior margin 13 proximate the anterior top edge 14 of the pad 2. The trough 10 eliminates contact of the hoof sole with the upper surface 4 of the pad 2, thereby providing relief of the pain that would otherwise be caused by contact of the surface 4 with the sole underlying the fragile distal border of the coffin bone. This relief is most important in “sinker” cases, where the coffin bone has prolapsed to the extent of protruding into the sole of the hoof, as shown in FIG. 1b.

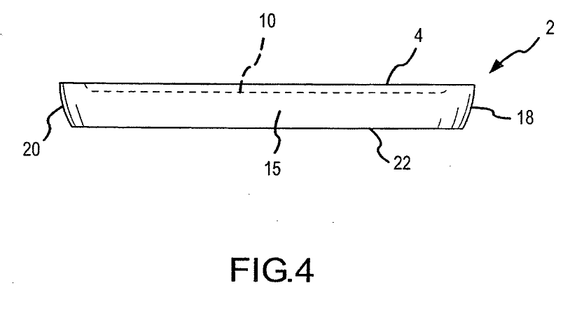

As seen in FIGS. 2, 3 and 4, all sides of the pad are tapered or sloped from the peripheral edge of its upper surface 4 inwardly toward its center. The intersection of the front sloping surface 15 and the bottom planar surface 22 of the pad 2 forms the modified front break over point 23, substantially posteriorly of the toe 24, the normal break over point. The anterior and posterior sloping side surfaces 15 and 16 have less slope than the medial and lateral side surfaces 18 and 20 because it is not necessary to modify the lateral and medial break over lines to the extent usually necessary for adjustment of the anterior break over line. The posterior slope 16 smoothes the horse's gait in a heel first plant of the hoof. As also seen in the drawings, each of the sloping side surfaces, 15,16,18 and 20 are interconnected by rounded curvilinear surfaces so that the pad 2 displays no sharp or abrupt corners. That portion of the flat upper surface 4 of the pad that is located posteriorly of the inner arc of the trough 10 serves to support the frog apex 25, the bars and the whole caudal aspect of the foot.

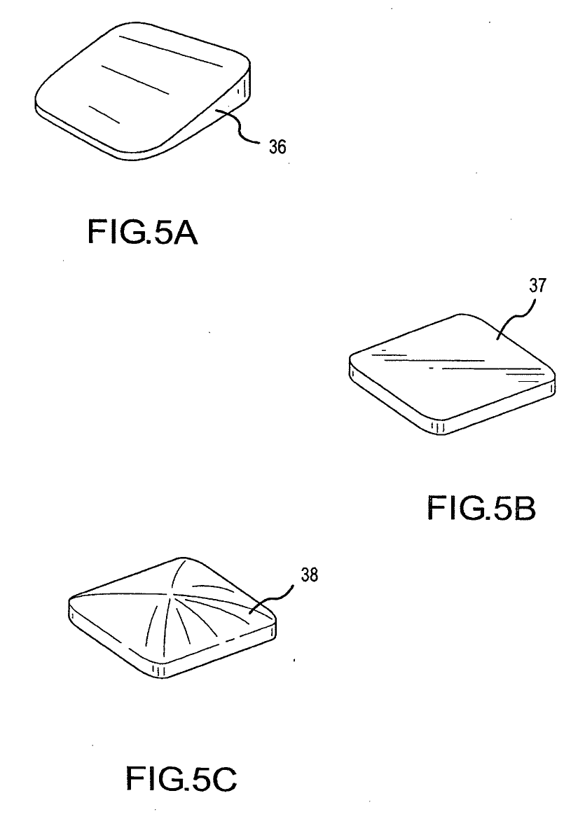

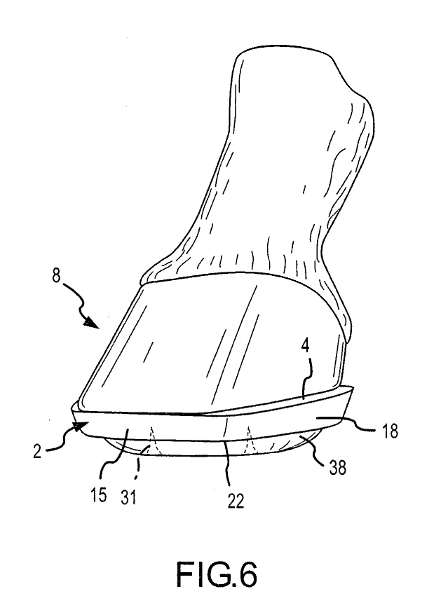

As discussed in the summary description of the invention, there are occasions when further modification of the break over lines is indicated, either laterally, medially or anteriorly. FIG. 5 illustrates three exemplary forms of supplemental pads 36, 37 and 38. These and other shapes of supplemental adjusting pads can be attached to the flat underside 22 of the primary pad 2 by screws 31. Such an attachment is shown in FIG. 6 where a crowned pad 38 is screwed to the bottom surface 22 of the pad 2.

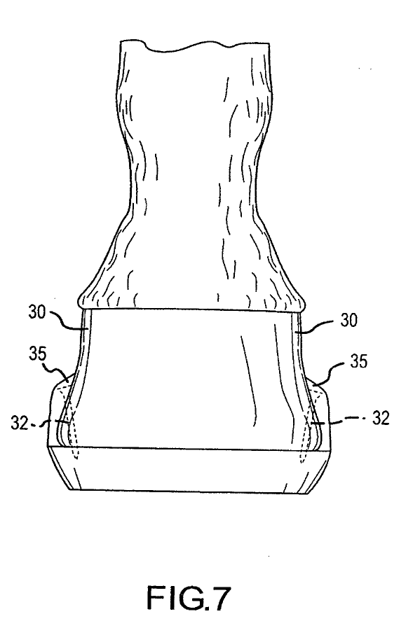

Nailing the pad 2 to the horse's hoof 8 with pummeling of the hoof that is associated with nail driving hammer blows is too traumatic and painful for a horse with laminitis. Accordingly, the preferred method of attaching the pad 2 to the horse's hoof is illustrated in FIG. 7. The foot is prepared flat to accept the flat upper surface 4 of the pad 2. The hoof wall 30 is pre-drilled from the ground-contacting side of the foot using location and hole angles similar to the location and the angles taken by standard horseshoe nails. Screws 32 are pre-set in the hoof wall from the top-side and screwed downwardly into the foot-contacting surface 4 of the pad 2.

If it is desired to compliment the screw attachments with adhesives, the outer surface of the hoof wall is prepared to receive the adhesive prior to inserting the screws 32. Unlike horseshoes or other foot treatment devices, the pad 2 is sized and dimensioned to be wider than the horse's foot in order to support and make contact with adhesive material 35. The adhesive is applied to the edges of the upper surface 4 of the oversized pad 2 and spread over the heads of the screws 32 protruding the from the outside wall of the hoof.

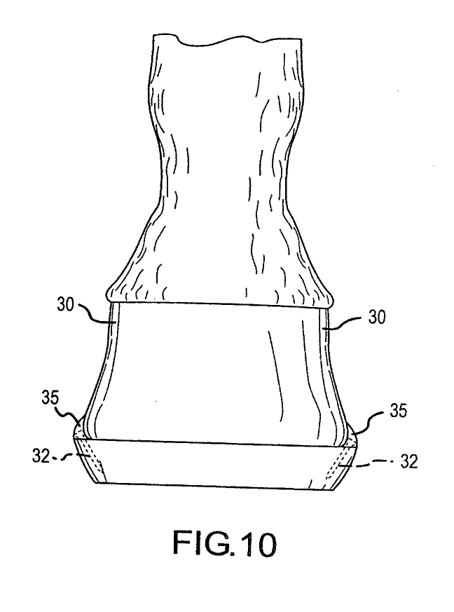

FIG. 10 illustrates an alternative non-invasive method of attachment where the screws 32 are not drilled into the hoof. The a plurality of screws are partially screwed angularly into that portion of the upper surface of the pad 2 that extends laterally from the edges of the hoof wall 30. The upper portion of each screw shank and the head of each screw act as stops or barriers to keep the hoof from moving laterally on the pad. A bead of adhesive 35 laid over the screw heads secures the hoof to the pad 2.

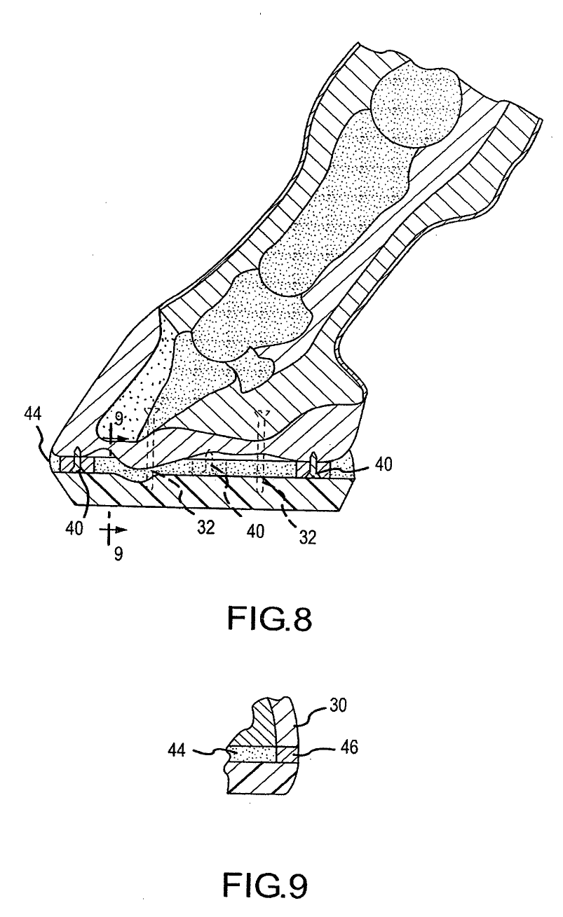

As seen in FIGS. 1c and 8, there are occasions when the distal border of the coffin bone has prolapsed to such an extent that the area of the sole near the apex of the frog 25 protrudes beyond the plane of the bottom edge of the hoof wall. In such a case the pad 2 cannot be applied directly to the bottom of the hoof, as shown in FIG. 3, but must be spaced away from the sole in order to avoid contact with the prolapsed center portion of the sole. To achieve the necessary spacing, the hoof is first substantially flattened. A rigid spacer 42 is next attached at each of the four corners of the hoof to the bottom edges of the hoof wall 30. Impression material 44, such as Performance Silicon's “Equisil,” or a similar silicon putty, is placed over the bottom of the hoof sole to such a depth as to be at least level with the bottom, or unattached free end, of each of the spacers 42. A hard flat impression plate is then taped to the bottom of the foot long enough for the impression material to set. After the impression plate is removed the impression material directly below the hoof wall and between each of the spacers 42 is trimmed away to provide space for the later placement of a strong hoof wall composite. Following trimming of the peripheral impression material, the upper surface 4 of the pad 2 is placed against the bottom end of each of the spacers 42 and secured thereto by screws 32 driven downwardly through the hoof wall in the same manner as earlier described in connection with FIG. 7. With the pad 2 secured to the hoof, the space between the bottom of the hoof wall and the upper surface 4 of the pad, which was created by trimming the impression material, is filled with hoof composite material 46 to form a rigid supporting extension of the hoof wall, as shown in FIG. 9. The impression material 44 covering the sole of the foot prevents the composite material from spilling into the interior of the space created by the spacers 42. In this configuration the advantages of the pad 2 are achieved while at the same time the prolapsed sole and the elastic impression material 44 disposed between the sole and upper surface 4 of the pad 2 supports the entire caudal aspect of the foot.

1. A hoof pad for treatment of equine lower limb pathology comprising,
a first block of rigid material having an upper hoof contacting surface and a lower flat surface and having a depth aspect between the upper and lower surfaces with sloping anterior, posterior, medial and lateral side surfaces that are curvilinearly interconnected and where the anterior and posterior side surfaces have a lesser slope than the medial and lateral side surfaces, said block having a plan view shape substantially similar to that of the ground contacting portion of a horse's hoof and adapted to cover the bottom profile of the hoof.

2. The hoof pad of claim 1 where the upper hoof-contacting surface is relieved to form a crescent shaped trough having a convex front margin proximate the anterior edge of the pad's upper surface.

3. The hoof pad of claim 2 where the upper hoof-contacting surface is substantially parallel with the lower flat surface.

4. The hoof pad of claim 2 and further comprising a second block of rigid material having an upper surface adapted for attachment to the lower flat surface of the first block and having a spaced apart lower ground contacting surface and anterior, posterior, medial and lateral side surfaces.

5. The hoof pad of claim 4 where the anterior, posterior, medial and lateral side surfaces are sloped with respect to the upper surface and said sloping surfaces are curvilinearly interconnected.

6. The hoof pad of claim 4 where the lower ground-contacting surface of the second block is laterally sloped with respect to the upper surface of the second block.

7. The hoof pad of claim 4 where the lower ground-contacting surface of the second block is axially sloped with respect to the upper surface of the second block.

8. A method for treating equine lower limb pathologies comprising the step of:
placing a flat upper surface of a rigid first pad to the ground-contacting surface of a hoof, where the upper surface of the first pad has an area greater than that of the bottom profile of the hoof and where a flat lower surface of the first pad has an area smaller than that of the bottom profile of the hoof.

9. The method of claim 8 where the flat upper surface and the flat lower surface of the first pad are interconnected by sloping side surfaces.

10. The method of claim 9 and further including the step of, securing the pad to the hoof with screws drilled into the pad through the sidewalls of the hoof.

11. The method of claim 8 and further including the step of, securing a second pad to the flat lower surface of the first pad.

12. The method of claim 11 where the second pad is in the shape of a wedge.

13. The method of claim 11 where the second pad is in the shape of a square.

14. The method of claim 11 where the second pad has a flat upper surface and a crowned lower surface that makes ground contact.

15. (canceled)
